(19) United States
(12) Patent Application Publication
(10) Pub. No.: US 2005/0160888 A1
(43) Pub. Date: Jul. 28, 2005

(54) Transport punch

(76) Inventor: Hendricus Antonius Hoogland, Krommenie (NL)

Correspondence Address: HOFFMANN & BARON, LLP, 6900 JERICHO TURNPIKE, SYOSSET, NY, 11791, US

(21) Appl. No.: 10/503,970

(22) PCT Filed: Feb. 7, 2003
(86) PCT No.: PCT/NL03/00089

(30) Foreign Application Priority Data
Feb. 8, 2002 (NL) 1019933

(51) Int. Cl. B26D 1/00; B26D 3/00

(52) U.S. Cl. 83/13

(57) ABSTRACT

The invention relates to a method for passing a foil web (5) over a guide surface (4), such that it extends over an opening (8) in the guide surface, wherein a foil web is used which is wider than the opening, calculated transversely to a passage direction for the foil web, on at least one and preferably both sides of which opening conveying means are provided with which the foil web is held against the guide surface and is moved over it. The invention further relates to an apparatus (1) for conveying a foil web (5) along a guide surface (4), wherein in or on the guide surface at least two conveying means extending approximately parallel to each other are provided with which a foil web can be gripped and can be moved along, at least over the guide surface and can be held against it simultaneously.

The invention relates to a method for passing a foil web over a guide surface.

From practice, methods are known for feeding foil webs, for instance in punching apparatuses, in which a foil web is passed from a feed-in roller over a guide surface, and in which the foil web is coiled again on a feed-out roller on the opposite side of the guide surface. In these apparatuses the feed-out roller is conventionally driven by means of a motor for moving the foil web. When using such a method in a punching apparatus, for instance, the foil web is repeatedly moved over approximately the length of a label to be punched out and an intermediate edge, a label is cut out and then the foil web is moved further again over the above distance, with the remaining part of the foil web being used to be coiled.

This known method has a number of drawbacks. Thus, for instance, the speed of the feed-out roller must be adjusted constantly, so that during increase in cross-section of the feed-out roller the proper transport distance is still obtained. Moreover, as a result of changing tensile stresses in the foil web, deformations will occur therein, in particular because the labels have been cut out of it, so that it is not sufficiently possible to accurately convey and position the foil web, in particular the labels to be cut out. This has the further drawback that relatively complicated and space-consuming apparatuses are required, and that adapting such an apparatus to a new product is relatively complicated and time-consuming.

The invention has for its object to provide a method of the type described in the opening paragraph, in which the aforementioned drawbacks are avoided, while retaining the advantages thereof To this end, a method according to the invention is characterized by the measures according to claim 1.

In a method according to the invention, the foil web is gripped on at least one and preferably on both sides of the opening, beside the opening, that is to say directly beside the part of the foil web to be processed. If, for instance, a label is cut out, then this is done between the strips of the foil web where it is gripped. Since the conveying means are situated in or on the guide surface, accurate conveyance of the foil web over the desired distance is simply possible. In fact, the conveying means always have to be driven over the same distance, irrespective of the position of the respective label in the foil web. A further advantage is that the foil web is held properly exactly where the treatment has to be carried out, so that undesired deformations, such as wrinkles, strains and the like can be prevented.

In a further advantageous embodiment a label is cut out of the foil web by means of a punch, in the respective opening, on both sides of which label a strip of the foil web is gripped by the conveying means, the label preferably being gripped in the opening or by the punch and being moved away from the guide surface, for instance to thus bring the label from the punch opening or from the punch into a mold cavity. The label may be delivered to, for instance, an insertion robot, but it is preferred that directly after gripping, that is to say without delivery to an interposed auxiliary means, the label is inserted in a mold cavity or, for instance, stacked in a stacking device.

The invention further relates to a method for forming a label for in-mold-labeling, characterized by the measures according to claim 5.

In such a method a foil web is passed through a punching apparatus, over a punch opening, on both sides of which punch opening vacuum-controlled conveying means are used with which the foil web, in slightly tautened condition, is passed over the opening and, moreover, along the above surface. By slightly tautening the foil web, the advantage is obtained that folds, wrinkles and the like are prevented even more easily. It will be clear that vacuum means have the advantage here that the foil web is drawn against the guide surface, which further simplifies positioning. For tautening may be used conveying means which, seen in the conveying direction, are slightly different from each other, such that the foil web is somewhat expanded widthwise.

The invention further relates to an apparatus for conveying a foil web along a guide surface, characterized by the measures according to claim 6.

With such an apparatus a foil web can be easily gripped and moved along the guide surface over any desired distance, while, moreover, it is ensured that the foil web remains in contact with the guide surface.

The conveying means preferably comprise vacuum means, in particular at least one perforated or otherwise air-permeable conveyor belt passed over a guide strip, with openings being provided in the guide strip, at least means for creating a reduced pressure, such that the or each conveyor belt functions as vacuum belt. Very accurate conveying means are thus obtained in a very simple manner.

It is preferred here that the conveying surface of each conveying means is approximately flush with the guide surface, so that folds and the like are even better prevented. Besides, it is observed that, as the occasion arises, a guide surface may also be used which is positioned a little higher than the conveying surface of the conveying means, which difference in height between the guide surface and the conveying means may decline, if required, such that the foil web is tautened further and optionally expanded a little. Of course, this may also be achieved in various other manners, which will be immediately clear to those skilled in the art.

In an apparatus according to the invention, a modular structure is preferably used. In particular, the punch opening with, if required, an associated punch knife and at least a part of the conveying means are provided in a module which is simply exchangeable, such that the apparatus can be very rapidly adapted to other labels. It is preferred here that in the same or comparable manner the corresponding punch knife is also included in an exchangeable module, just as, if required, the relevant parts of an insertion robot, mold parts and the like.

In a further elaboration, the feed-in roller and the feed-out roller are also arranged on the module in which the above punch opening is provided, such that they are exchangeable together with the module.

Further advantageous embodiments of an apparatus and a method according to the invention are described in the further subclaims. To explain the invention, exemplary embodiments of a method and an apparatus according to the invention will be specified with reference to the drawing, in which:

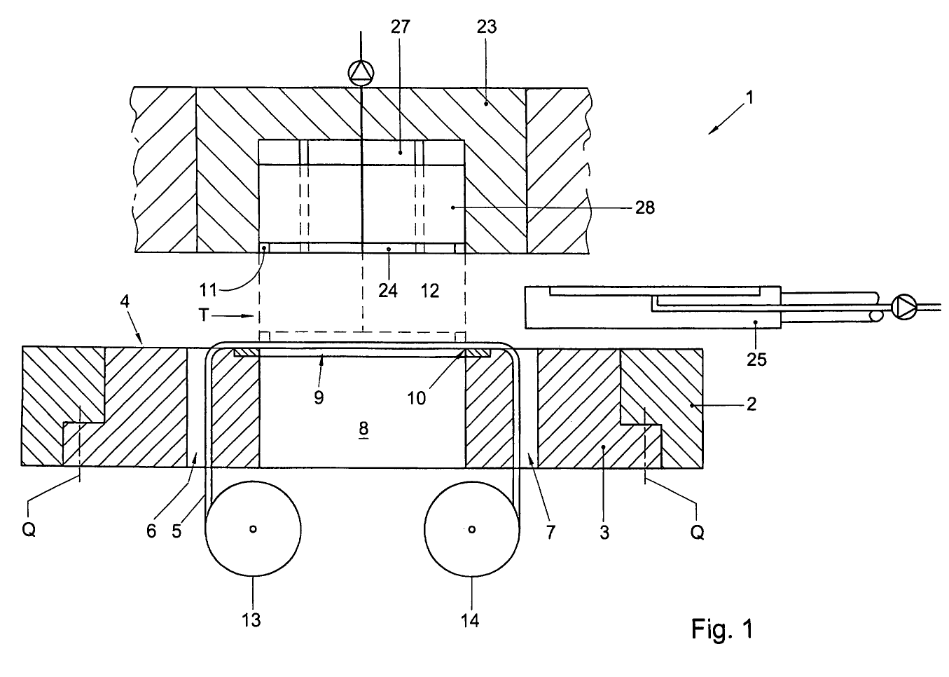

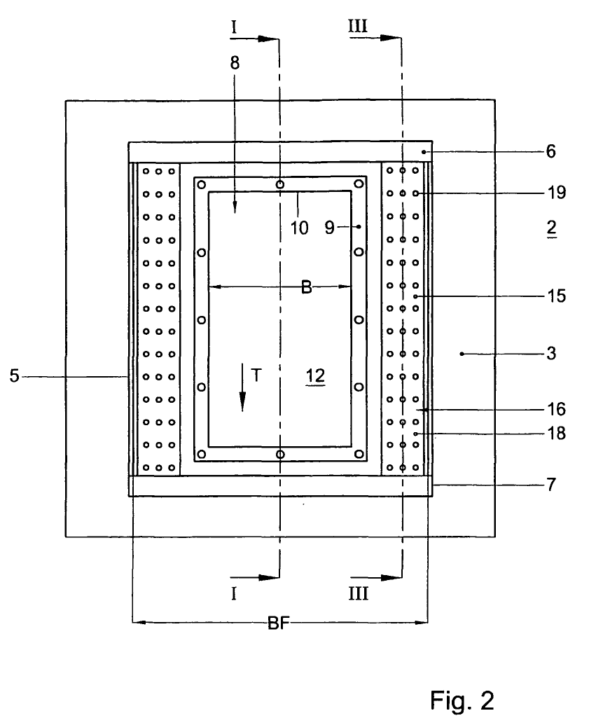

FIG. 1 diagrammatically shows, in sectional side view along the line I-I in FIG. 2, an apparatus according to the invention;

FIG. 2 diagrammatically shows, in top view, a module according to the invention;

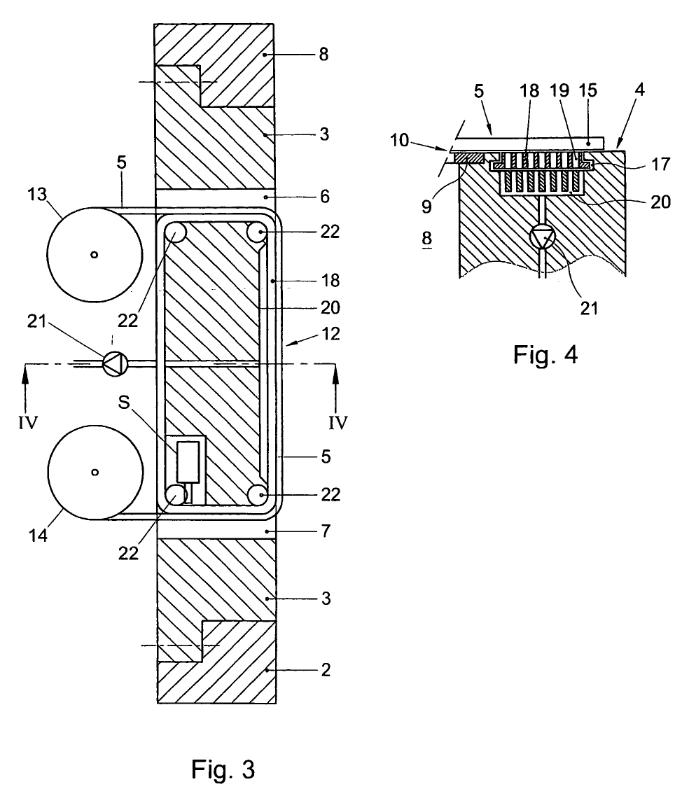

FIG. 3 diagrammatically shows, in sectional side view along the line III-III, the apparatus according to FIG. 2;

FIG. 4 shows, in sectional view along the line IV-IV in FIG. 3, a part of the conveying means with foil web; and

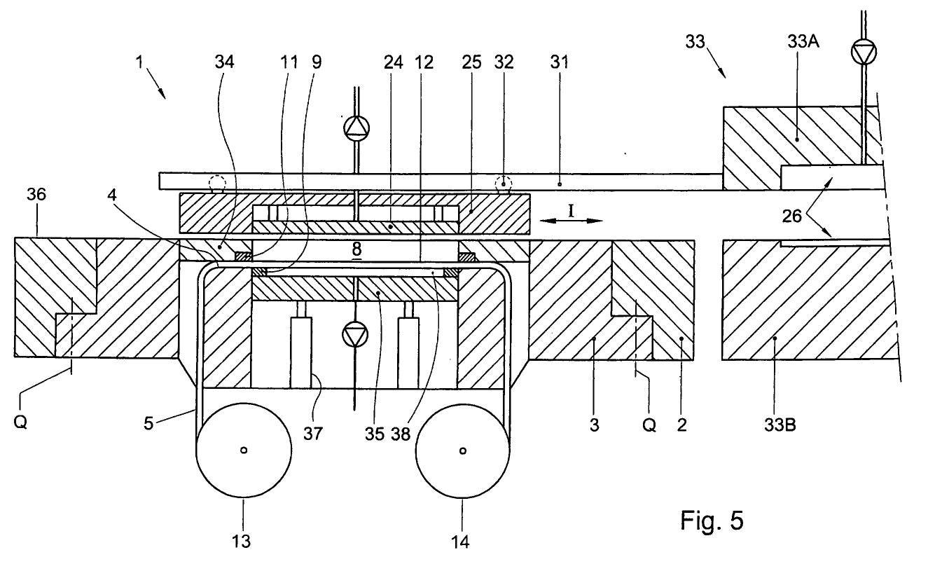

FIG. 5 shows, in sectional side view comparable to FIG. 1, an alternative embodiment of an apparatus according to the invention.

In this specification, similar or corresponding parts have similar or corresponding reference numerals. As exemplary embodiments are described in this specification methods and apparatuses for manufacturing labels for use in in-mold labeling apparatuses. It will be clear, however, that other uses are also possible.

FIG. 1 diagrammatically shows, in sectional side view along the line I-I in FIG. 2, an apparatus 1 according to the invention, comprising a frame 2 with a module 3 therein. The module 3 is fittingly received in the frame, such that the surface of the module and that of the frame form a substantially flat guide surface 4. Besides, as the occasion arises, the guide surface may also completely be formed by the surface of the module 3. On a first side of the module a first passage slit 6 is provided through which a foil web 5 can be fed, on to the guide surface 4, while on the opposite second side a second passage slit 7 is provided for feeding out the foil web 5 again, at least the remaining part thereof, as will be specified lower down. The foil web is relatively thick in the drawing, for clarity's sake. It will be clear, however, that very thin foils can be used, for instance a few tens of micrometers. The module 3 is detachably attached in the frame, for instance with unspecified, known per se means, indicated by the dash-dot lines Q, such as clamping means, bolts, form closure or the like. As a result, the module 3 as a whole is easily exchangeable for another module 3.

The module 3 comprises a central opening 8, surrounded by a first punch knife 9, at least a cutting edge 10. As will be specified lower down, there is further provided opposite the opening 8 a second punch knife 11 having a form complementary to the opening, at least the first punch knife 9, and can be moved such that the first and the second punch knife 9, 10 together can punch, at least cut, a label 12 out of the foil web.

On the side of the module 3 remote from the second punch knife 11, a feed-in roller 13 and a feed-out roller 14 are provided for respectively the uncut foil web 5 to be fed in and the remaining foil to be fed out. The feed-in roller 13 and the feed-out roller 14 are arranged such that the foil web 5 can be passed through the slits 6, 7. The longitudinal edges of the module are, near the slits 6, 7, rounded or designed as rolls or the like so as to prevent damage to the foil web 5. The feed-out roller 14 may optionally be driven for coiling the remaining foil web.

As clearly shown in FIG. 2, the width B of the opening 8 is, seen transversely to the conveying direction T, smaller than the corresponding width BF of the foil web 8. Consequently, on both sides of the opening 8 a longitudinal strip 15 of the foil web 5 abuts on the guide surface of the module 3. In FIG. 2 the foil web 5 is transparent. As a result, the subjacent conveying means 16 are visible.

The conveying means 16 comprise, as clearly shown in FIGS. 3 and 4, a conveyor belt 18 located in a trough 17 and provided with an air-permeable surface. In the embodiment shown, this is achieved by providing rows and columns of openings 19 in the conveyor belt. In the bottom of the trough 17 are also provided openings 20 through which air can be extracted by means of a pump 21, in particular a vacuum pump. Preferably, the conveyor belt 18 nearly completely abuts on the bottom of the trough and, if required, additionally abuts on the longitudinal walls of the trough 17. As a result, air can only be extracted through the openings 20 when drawn in through the openings 19 in the conveyor belt 18. Thus a vacuum belt is obtained. The conveyor belt is passed over rollers 22, at least one of which is driven, preferably by a stepping motor S. Surprisingly, it has been found that by drawing in air via the openings 19 and 20 foil can be drawn against the conveyor belts 18 and is thereby held, such that when driving the conveyor belts 18 in the conveying direction T the foil web 5 is moved along and can be conveyed very accurately. The rollers 22 and the drives therefor are preferably also arranged in, at least on the module 3, so that they can be exchanged together with the module 3. As a result of the chosen conveying direction 16, with the foil web being drawn against the guide surface as a result of the reduced pressure and additionally being kept taut by the conveyor belts extending on both sides of the punch opening 8, labels can be cut or punched very accurately, even in case of extremely thin foil webs 5, for instance less than 50 micrometers or even 20 micrometers or less.

In the embodiment shown in FIG. 1, the second punch knife 11 is included in a punch unit 23 also designed as module. The second punch knife surrounds a vacuum plate 24 with which during or immediately after cutting or punching the label 12 can be gripped and taken along, away from the module 3, so as to be delivered to an insertion robot 25 which, also by means of vacuum, can place the label 12, preferably in a slightly taut condition, in a mold cavity 26 (as shown in FIG. 5). Such an insertion robot is extensively described in the international patent application PCT/NL00/00581, which is inserted herein by reference. However, all kinds of other insertion robots, at least means for placing labels at suitable positions, may of course also be used in an apparatus 1 according to the invention.

The punch unit 23 is provided with a cavity 27 in which the vacuum plate 24, carried by a guide block 28, is movably received for movement by means of piston-cylinder assemblies 29. The second punch knife 11 can therefore be pressed through the foil web into the opening 8, with the label 12 being held, after which the label can be delivered to the insertion robot. If required, the whole punch unit 23 may of course also be movably arranged, with the second punch knife 11 projecting outside the surface 30 facing the foil web 5. Many variations are possible here for cutting the labels 12 from the foil web and transferring them to a mold cavity or, for instance, a stacking unit for stacking the labels for further use. Because the labels 12 are cut from the foil web 5, with the longitudinal strips 15 being retained in the foil web, conveyance with the conveying means 16 is easily possible, the remaining foil web 5 can easily be coiled and, moreover, each label can have any desired form. In the drawing, a rectangular label is shown, but it may also have another form, for instance another regular or irregular polygon, a “Maltese cross” or another form.

A module 3, the associated punch unit 23, and optionally the gripping means of the insertion robot 25 are adjusted to each other and can easily be exchanged, together with the associated mold, so that adjusting times are reduced to a minimum.

In the embodiment shown in FIG. 5, a guide rail 31 is provided from which the insertion robot 25 is suspended by means of wheels 32 or the like for reciprocating movement in the direction I. The guide rails 31 extend into a mold part of the mold 33 partly shown, in which the mold cavity 26 is clearly visible. The insertion robot 25 can therefore be moved along the guide rail 31, until the vacuum plate 24 has been brought above the mold cavity 26, after which a label can be delivered. When the insertion robot has been moved away from between the two mold parts 33A, 33B, back to the position shown in FIG. 5, the mold 33 can be closed and a product can be formed therein, in-mold-labeled. Such a production technique is sufficiently known per se.

In this embodiment the guide surface 4 in the module 3 is slightly recessed relative to the upper surface 36 of the frame 8, such that a stripping plate 34 could be placed above the guide surface 4, of which the side facing the insertion robot 25 is preferably approximately flush with the surface 36. Provided in the stripper plate 34 is the punch opening 8, which is surrounded on the side facing the guide surface 4 by the second punch knife 11. The first punch knife 9 is supported on the opposite side of the foil web 5 by a punch plate 35, which is movable with piston-cylinder assemblies 37 or such means. Supported on the punch plate 35 is a second vacuum plate 38, surrounded by the first punch knife 9. With this the foil web 5, at least the label 12, can be gripped, in particular during punching, which takes place by moving up the punch plate 35 by means of the piston-cylinder assemblies 37 in FIG. 5, through the opening 8, to near the vacuum plate 24 of the insertion robot 25. The label is delivered 12 thereto, so that it can be brought into the mold cavity 26 in the manner described before. It will be clear that in the module 3, as shown in FIG. 5, conveying means 16 are included, as described on the basis of FIGS. 3 and 4 in particular, for transporting the foil web 5 along the guide surface 4 and the opening 8.

In the embodiment shown in FIG. 5, the advantage is obtained that the label 12 can be delivered directly from the punch plate 35 to the insertion robot 25 for placement in the mold cavity 26. It will be clear that it is also possible to position the module 3 into the insertion robot 25, so that a label 12 can thus be directly pressed through the punch opening 8 in the mold cavity 26, after which the insertion robot 25 is moved away from between the mold halves 33A, 33B and a product is formed. Delivery of the label 12 is thus prevented completely.

It will be clear that the invention is by no means limited to the exemplary embodiments described in the specification and shown in the drawings. Many variations thereof are possible within the framework of the invention defined by the claims.

Thus, in one frame 2 more than one module may be included, for instance a series of modules beside and/or above each other, so that, for instance, labels can be manufactured by a multiple mold. Also, instead of punching operations other operations may be carried out on the foil web, for instance the application of printings. Instead of perforated conveyor belts, other conveying means may of course also be used, for instance otherwise air-permeable conveyor belts, conveyor mats, statically charged belts and the like. Also, in particular in, for instance, an embodiment as shown in FIG. 5, there may be provided on both sides of the foil web, on both sides of the opening, cooperating conveyor belts or the like, such that the longitudinal edges 15 of the foil web 5, on both sides of the opening 8, are clamped between the cooperating belts, while, optionally, the aforementioned reduced pressure, at least vacuum, may be omitted. There may further be made combinations of the exemplary embodiments shown and described, in particular also with insertion robots, as described in the aforementioned international patent application. Although modular structure is preferred, an apparatus according to the invention may also be built up in one part, that is to say non-modular. The feed-in roller and the feed-out roller may also be replaced by other means, while, moreover, they may also be positioned otherwise. In particular, they may be included in, for instance, the module, for instance beside the respective slits 6, 7 on the side thereof remote from the opening 8, so that the structure can be compacter, at least in thickness. Also, means may be provided for cutting off the remaining foil web, after it has passed the opening, so that this part of the foil web need not be coiled and can be fed out directly. The insertion robot may be moved otherwise, for instance with rod mechanisms, rotating mechanisms and the like.

These and many variations are considered to fall within the framework of the invention defined by the claims.

1. A method for passing a foil web over a guide surface, such that it extends over an opening in the guide surface, wherein a foil web is used which is wider than the opening, calculated transversely to a passage direction for the foil web, on least one and preferably both sides of the opening conveying means being provided with which the foil web is held against the guide surface and is moved over it.

2. A method according to claim 1, wherein the foil web is passed over the opening and a label is cut out of the foil web by means of a punch or such cutting means, in the respective opening, on both sides of the label a strip of the foil web being gripped by the conveying means for holding the foil web and conveying it along the guide surface.

3. A method according to claim 2, wherein the label is gripped in the opening or by the punch and is moved away from the guide surface.

4. A method according to claim 3, wherein the label is brought from the punch opening or from the punch into a mold cavity, preferably without delivery to an interposed auxiliary means, after which a product is injection molded in the mold cavity.

5. A method for forming a label for in-mold-labeling wherein a foil web is passed by a punching apparatus over a punch opening, on both sides of which punch opening vacuum-controlled conveying means are used in or against the surface in which the punch opening is provided, by means of which conveying means the foil web is slightly tautened over the opening and, moreover, the foil web is passed along said surface.

6. An apparatus for conveying a foil web along a guide surface, wherein in or on the guide surface at least two conveying means extending approximately parallel to each other are provided, with which a foil web can be gripped and can be moved along, at least over the guide surface, and can be held against it simultaneously.

7. An apparatus according to claim 6, wherein the conveying means comprise vacuum means, in particular at least a perforated or otherwise air-permeable conveyor belt which is passed over a guide strip, in which guide strip openings are provided for creating a reduced pressure, such that the or each conveyor belt functions as vacuum belt.

8. An apparatus according to claim 6, wherein each conveying means is recessed in the guide surface such that it has a conveying surface which is approximately flush with the guide surface.

9. An apparatus according to claim 6, wherein a punch opening is provided between the conveying means.

10. An apparatus according to claim 9, wherein a series of punch openings is provided, each punch opening being provided between two conveying means.

11. An apparatus according to claim 9, wherein the punch opening is provided with, if required, a punch knife in a removable module, in which module are also provided at least a part of the conveying means.

12. An apparatus according to claim 11, wherein a punch is provided for punching a label out of a foil web in or through the or each punch opening, means being provided for receiving the or each label and transferring it to a mold cavity, the or each punch, the or each punch opening with associated conveying means and the means for receiving and transferring the or each label being exchangeable for comparable means for another production mold, by only exchanging modules.

13. An apparatus according to claim 11, wherein in the or each module in which a punch opening and conveying means are included means are also provided for receiving a roll of foil and means for coiling a foil web from which labels are cut.
